(19) United States
(12) Patent Application Publication
(10) Pub. No.: US 2013/0226661 A1
(43) Pub. Date: Aug. 29, 2013

(54) Methods and Electronic Commerce Systems for Updating and Displaying the Price of Goods

(71) Applicant: Sarah Barber, Cincinnati, OH (US)

(72) Inventor: Sarah Barber, Cincinnati, OH (US)

(21) Appl. No.: 13/776,924

(22) Filed: Feb. 26, 2013

Related U.S. Application Data
(60) Provisional application No. 61/604,028, filed on Feb. 28, 2012.

(51) Int. Cl. G06Q 30/02

(52) U.S. Cl. CPC G06Q 30/0202
USPC 705/7.31

(57) ABSTRACT

Methods and electronic commerce systems for updating and displaying the price of goods are disclosed. A method for displaying an updated price of a good includes determining, automatically by a computing device, a current sales velocity. The current sales velocity is a sold quantity of the good during a current period. The current period spans a previous time and a current time. The method further includes determining a previous sales velocity. The previous sales velocity is a sold quantity of the good during a previous period. The previous period spans a preceding previous time and the previous time. The method further includes updating the price of the good based on the current sales velocity and the previous sales velocity, and providing for display the updated price of the good on a display device.

### CLAIM OF PRIORITY

This application claims the benefit of U.S. Provisional Application No. 61/604,028, entitled “Systems And Methods For Selling Goods Through Electronic Commerce,” filed Feb. 28, 2012, the entirety of which is hereby incorporated by reference.

### BACKGROUND

1. Field

The present specification generally relates to methods and electronic commerce systems for pricing goods and, more specifically, to methods and electronic commerce systems for updating and displaying the price of goods.

2. Technical Background

When selling goods, such as through electronic commerce systems, it may be desirable to price the goods in order to enhance profit. It may be impossible to predict the appropriate price point for a good before some of the good is sold. For example, a good may be priced lower than a purchaser is willing to pay, resulting in sub-optimal profits from the additional price that the purchaser would pay. Similarly, a good may be priced higher than a purchaser is willing to pay, resulting in sub-optimal profits from the lost quantity that otherwise might be sold. It may be desirable to appropriately price the good to mitigate such lost profits.

Accordingly, a need exists for methods and electronic commerce systems for updating and displaying the price of goods.

### SUMMARY

According to economic theory, in a competitive equilibrium market, the equilibrium price is determined where the supply of goods matches the demand. The unit price for goods in a market can be approximated by the economic model of supply and demand. The price that is determined by the free market for a certain good often represents the value that it gives the consumers. At this equilibrium price, consumer's surplus equals the producer's surplus. Consumer's surplus is the value that the consumer receives by being able to purchase a product for the equilibrium price that is less than the maximum price that they would be willing to pay. Producer surplus, on the other hand, is the value that producers receive by selling at an equilibrium price that is higher than the minimum price that they would be willing to sell. In many instances, the unit price for a good cannot be determined prior to producing the good. Accordingly, the good may be sold at too low of a price, or too large of a quantity of goods may be produced resulting in inventory. In either event, the profit from sales of the goods at the unit price can be less than optimal.

When an item is scarce, the supply is less. Thus the equilibrium price is higher than when the supply is not scarce. In these circumstances, a less necessary good can be much higher priced solely because of scarcity. In addition to scarcity, if a good is considered valuable because it is rare or unique, there is an increased price to compensate for this situation. Scarcity and rarity may be managed to improve profitability. Scarcity, as used herein, means a shortage of supply and rarity, as used herein, means a good is unique, uncommon, or unusual.

To develop scarcity, the quantity of goods available to a market can be made less than the market demands. Moreover, a company can manage inventory to increase profits. Specifically, at each point in time when the company orders its product to sell, it can order a limited quantity (allocated quantity). Thus when the company goes to provide the product for sale to the market place, it will only have the allocated quantity of product to sell. Further, there can be a limited time (pre-purchase time period) when consumers can “pre-purchase” products. The pre-purchase time period can be the length of time from when the company contacts suppliers with the purchase order for products to when the products are available to ship. In one embodiment, the pre-purchase time period time can be equal to the lead-time from the supplier. If any inventory remains after the pre-purchase time period, it can be sold off at a discounted price (current offering price) until completely sold out. Thus, going into the next period, there can be zero carrying cost for inventory.

In addition to scarcity, when the company goes to offer a product in the market place, there can be something special that makes it rare and unique. For example, popular brands may sell due to name on the product. Whether it is different in design, shape, or anything, each product offered can be viewed as a “one-of-a-kind”. Creating originality in products can result in the creation of rarity. Because scarcity can be controlled through the zero-inventory concept and consumers participate in the pre-purchase time period, there can be increased ability to control and impact the rarity of the products offered. Further, after the product has the view of being a rare good, the price can be increased. In addition to the higher price, the scarcity of the product allows the price to be reflective of the demand and therefore increasing as the demand for the limited quantity of product accelerates.

The embodiments described herein can be employed to optimize cash flow and reduce inventory costs. Moreover, the faster inventory is sold, the lower the inventory costs and the higher the cash flow. Zero-inventory can be achieved by buying limited quantity of products and selling until the limited quantity is depleted. In some embodiments, to ensure that inventory is depleted quickly, inventory can be managed such that each product purchased will be unique and never reproduced at a later date. Thus, consumers can buy a unique item and because each item is rare, they can be sold on an increasing price platform. The increasing price presumption can be such that each product sold will be reflective of its individual demand. If demand increases at a very high rate, the price will increase in proportion to that rate. Assumptions of demand can be input into the embodiments described herein.

The embodiments described herein may be utilized for profit maximization and brand development. The embodiments described herein may utilize increased rarity and scarcity of goods to be sold to improve profitability by imposing an increasing price algorithm. The embodiments described herein may be employed to improve cash flow by moving inventory in an expeditious manner.

In one embodiment, a method for displaying an updated price of a good includes determining, automatically by a computing device, a current sales velocity. The current sales velocity is a sold quantity of the good during a current period. The current period spans a previous time and a current time. The method further includes determining a previous sales velocity. The previous sales velocity is a sold quantity of the good during a previous period. The previous period spans a preceding previous time and the previous time. The method further includes updating the price of the good based on the current sales velocity and the previous sales velocity, and providing for display the updated price of the good on a display device.

In another embodiment, an electronic commerce system includes at least one processor, a memory communicatively coupled to the at least one processor, and machine readable instructions stored in the memory. The machine readable instructions, when executed by the at least one processor, cause the electronic commerce system to determine a current sales velocity. The current sales velocity is a sold quantity of the good during a current period. The current period spans a previous time and a current time. The machine readable instructions further cause the electronic commerce system to determine a previous sales velocity. The previous sales velocity is a sold quantity of the good during a previous period. The previous period spans a preceding previous time and the previous time. The machine readable instructions further cause the electronic commerce system to update the price of the good based on the current sales velocity and the previous sales velocity.

In yet another embodiment, an electronic commerce system includes at least one processor, a memory communicatively coupled to the at least one processor, and machine readable instructions stored in the memory. The machine readable instructions, when executed by the at least one processor, cause the electronic commerce system to calculate a pre-purchase price of a good during a pre-purchase time period. The pre-purchase price is associated with a limited quantity of the good available for sale during the pre-purchase time period. The machine readable instructions further cause the electronic commerce system to transmit the pre-purchase price of a good, determine a sold quantity of the good during a current period within the pre-purchase time period, calculate a risk metric based on the limited quantity and the sold quantity, transmit the risk metric, calculate a current offering price, and transmit the current offering price during a current offering time period. The current offering price is lower than the pre-purchase price.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an electronic commerce system according to one or more embodiments shown and described herein; and

FIG. 2 schematically depicts a flowchart for updating the price of a good, according to one or more embodiments shown and described herein.

### DETAILED DESCRIPTION

Referring generally to the figures, the embodiments described herein may automatically determine a current sales velocity, determine a previous sales velocity, and update the price of the good based on the current sales velocity and the previous sales velocity. The current sales velocity is a sold quantity of the good during a current period. The current period spans a previous time and a current time. The previous sales velocity is a sold quantity of the good during a previous period. The previous period spans a preceding previous time and the previous time. Some embodiments may provide the updated price of the good for display on a display device. By updating the price of goods as the quantity of the goods changes over time, enhanced profits from the sale of the goods may be realized. Various embodiments of the methods and electronic commerce systems for updating and displaying the prices of goods will be described in more detail herein.

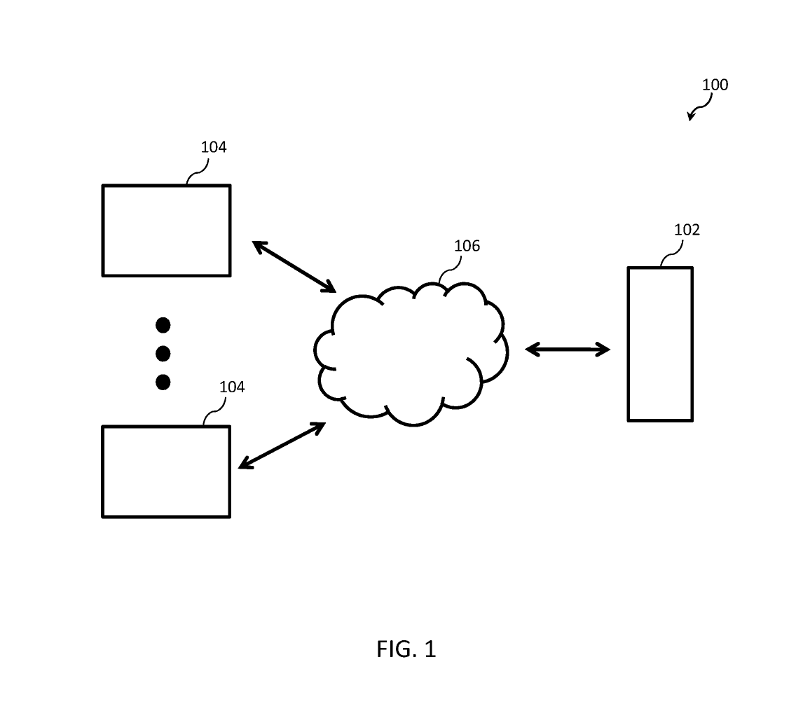

Still referring to FIG. 1, the electronic commerce system 100 generally comprises at least one server 102 for interacting with one or more clients 104. The server 102 can be communicatively coupled to at least one processor that executes machine readable instructions stored in memory that cause the electronic commerce system to perform one or more aspects of the functionality described herein when executed by the at least one processor. As used herein, the term “communicatively coupled” means that the components are capable of exchanging data signals with one another such as, for example, electrical signals via conductive medium, electromagnetic signals via air, optical signals via optical waveguides, and the like.

According to the embodiments described herein, a processor means any device capable of executing machine readable instructions. Accordingly, each processor may be a controller, an integrated circuit, a microchip, a computer, or any other computing device. The at least one server 102 can also be communicatively coupled to a memory such as, for example, RAM, ROM, a flash memory, a hard drive, or any device capable of storing machine readable instructions.

Embodiments of the present disclosure can include machine readable instructions or an algorithm written in any programming language of any generation (e.g., 1GL, 2GL, 3GL, 4GL, or 5GL) such as, e.g., machine language that may be directly executed by the processor, or assembly language, object-oriented programming (OOP), scripting languages, microcode, etc., that may be compiled or assembled into machine readable instructions and stored on a machine readable medium. Alternatively, the logic or algorithm may be written in a hardware description language (HDL), such as logic implemented via either a field-programmable gate array (FPGA) configuration or an application-specific integrated circuit (ASIC), and their equivalents. Accordingly, the logic may be implemented in any conventional computer programming language, as pre-programmed hardware elements, or as a combination of hardware and software components.

In one embodiment, the at least one server 102 can be communicatively coupled to the one or more clients 104 over a network 106 that may include one or more cellular networks, satellite networks and/or computer networks such as, for example, a wide area network, a local area network, personal area network, and combinations thereof. Accordingly, the at least one server 102 can be communicatively coupled to the network 106 via wires, via a wide area network, via a local area network, via a personal area network, via a cellular network, and the like. Suitable local area networks may include wired ethernet and/or wireless technologies such as, for example, Wi-Fi. Suitable personal area networks may include wireless technologies such as, for example, IrDA, Bluetooth, Wireless USB, Z-Wave, ZigBee, and the like. Alternatively or additionally, suitable personal area networks may include wired computer buses such as, for example, USB and FireWire. Suitable cellular networks include, but are not limited to, technologies such as LTE, WiMAX, UMTS, CDMA, and GSM. Accordingly, the network 106 can include the Internet or World Wide Web.

In one embodiment, the at least one server 102 can be utilized to provide resources to a client 104 over the World Wide Web, i.e., transmit data to and receive data from a web browser. The at least one server can also be utilized to provide resources (e.g., processing, storage, software, and data) to a client 104 over any other type of network 106. It is noted that, while the server 102 and the client 104 are depicted in FIG. 1 as sharing resources via a client-server relationship, the at least one server 102 and the one or more clients can cooperate to share resources with one another such as in a peer-to-peer network.

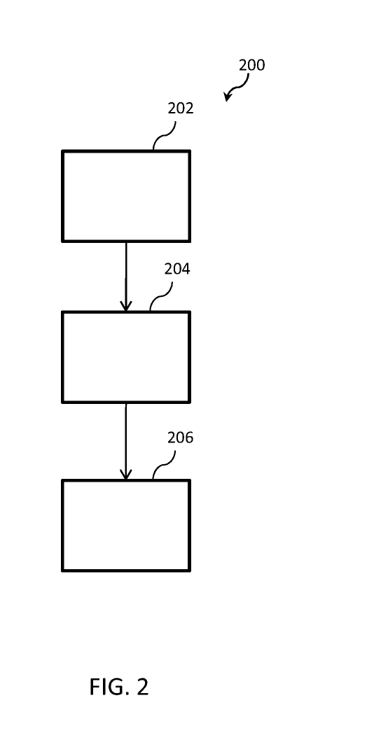

Referring now to FIG. 2, a flowchart of an algorithm 200 employed by the server 102 for updating the price pₜ of a good at a current time t is schematically depicted. At block 202, the server 102 determines a current sales velocity Vₜ at the current time t. The current sales velocity Vₜ is the sold quantity of the good during a current period, which spans a previous time t−1 and the current time t. In some embodiments, the current sales velocity Vₜ=qₜ₋₁−qₜ, where qₜ₋₁ is the quantity of the good remaining at the previous time t−1 and qₜ is the quantity of the good remaining at the current time t.

At block 204, the server 102 determines a previous sales velocity Vₜ₋₁ at the previous time t−1. The previous sales velocity Vₜ₋₁ is the sold quantity of the good during a previous period, which spans a preceding previous time t−2 and the previous time t−1. In some embodiments, the previous sales velocity Vₜ₋₁=qₜ₋₂−qₜ₋₁, where qₜ₋₂ is the quantity of the good remaining at the previous preceding time t−2 and qₜ₋₁ is the quantity of the good remaining at the previous time t−1.

At block 206, the server 102 updates the price of the good pₜ based on the current sales velocity Vₜ and the previous sales velocity Vₜ₋₁. In some embodiments, a current sales acceleration Aₜ is calculated by subtracting the previous sales velocity Vₜ₋₁ from the current sales velocity Vₜ (i.e., Aₜ=Vₜ−Vₜ₋₁) and the price of the good pₜ is updated based on the current sales acceleration Aₜ. However, it should be understood that in other embodiments, the price of the good pₜ may be updated based on the current sales velocity Vₜ and the previous sales velocity Vₜ₋₁, but not the current sales current sales acceleration Aₜ.

In some embodiments in which the price of the good pₜ is updated based on the current sales acceleration Aₜ, a current demand Dₜ is calculated based on the current sales acceleration Aₜ and the price of the good pₜ is updated based on the current demand Dₜ. In some embodiments, the current demand Dₜ is calculated based on the current sales acceleration Aₜ according to a first relation: if Aₜ=0 then Dₜ=0. In some embodiments (e.g., when Aₜ≠0): the current demand Dₜ is calculated based on the current sales acceleration Aₜ according to a second relation, in which Aₜ₋₁ is a previous sales acceleration at a previous time t−1, q̅ is an initial quantity of the good, and p_{max t-1} is a previous maximum price at a previous time t−1:

$${A}_{t} < 0 ⋂ {A}_{t - 1} < 0 \to {D}_{t} = \frac{\frac{{V}_{t}}{\overline{q} - {q}_{t}} \cdot {A}_{t - 1} {A}_{t}}{{p}_{{max}_{t - 1}}}$$

In other embodiments (such as when Aₜ≠0 and (Aₜ≧0 or Aₜ₋₁≧0)): the current demand Dₜ is calculated based on the current sales acceleration Aₜ according to a third relation, in which the current demand Dₜ is calculated based on a previous maximum price p_{max t} by: (i) determining an acceleration difference by subtracting a previous sales acceleration Aₜ₋₁ from the current sales acceleration Aₜ; and (ii) dividing the acceleration difference by the previous maximum price p_{max t-1} to arrive at the current demand Dₜ, as shown below:

$${D}_{t} = \frac{{A}_{t} - {A}_{t - 1}}{{p}_{{max}_{t - 1}}}$$

In some embodiments that include calculating a current demand Dₜ, a current maximum price p_{max t} (indicative of a maximum price of the good at the current time t) may be calculated based on the current demand Dₜ and a previous maximum price p_{max t-1} (indicative of a maximum price of the good at the previous time t−1). For example, in some embodiments, when the current demand Dₜ is zero, the current maximum price p_{max t} is set to the previous maximum price p_{max t-1}, as indicated in the following relation:

Dₜ=0→pₘₐₓ_{ₜ}=pₘₐₓ_{_{t−1}}

In some embodiments (e.g., when Dₜ≠0), the current maximum price p_{max t} may be calculated based on the current demand Dₜ and the previous maximum price p_{max t-1} as follows:

pₘₐₓ_{ₜ}=(1+Dₜ)·pₘₐₓ_{_{t−1}}

In some embodiments, when the current quantity qₜ is zero, the price of the good pₜ is updated based on the previous maximum price p_{max t-1}. For example, in some embodiments the price of the good pₜ is updated according to the following relation:

qₜ=0→pₜ=pₘₐₓ_{_{t−1}}

In other embodiments (e.g., embodiments in which qₜ0), when Vₜ=0, the price of the good pₜ is updated based on the previous price pₜ₋₁ at the previous time t−1, the current quantity qₜ, and the initial quantity q̅. For example, the price of the good pₜ is updated according to the following relation:

$$\frac{{V}_{t}}{{q}_{t}} = 0 \to {p}_{t} = {p}_{t - 1} \cdot ( 1 - \frac{{q}_{t}}{\overline{q} \cdot t} )$$

In other embodiments (e.g., embodiments in which qₜ≠0 and Vₜ≠0), the price of the good pₜ is updated based on the previous maximum price p_{max t-1} at the previous time t−1, a base price p̅, an initial maximum price p̅ₘₐₓ, the current time t, the current sales velocity Vₜ, the current quantity qₜ, and a maximum time period Tₘₐₓ. For example, in some embodiments, the price of the good pₜ is updated according to the following relation:

$${p}_{t} = \frac{{p}_{{max}_{t - 1}}}{1 + ( \frac{\overline{p}}{{\overline{p}}_{max}} + 1 ) \cdot {( 1 + \frac{t}{{T}_{max}} + \frac{{V}_{t}}{{q}_{t}} )}^{- t}}$$

In some embodiments, the price of the good is updated during a fixed period and only a limited quantity of goods are available for sale during the fixed period, such as when a limited quantity of goods are available for purchase during a pre-purchase time period and the pre-purchase price of the good is updated during the pre-purchase time period according to the algorithm 200.

In some embodiments, once the price of the good is updated at block 206, the updated price of the good may be provided for display on a display device (e.g., a monitor, a touchscreen, etc.) coupled to a computing device, such as when the updated price of the good is displayed on a monitor coupled to the client 104.

### EXAMPLE

One example application of the algorithm 200 described above will now be provided. However, it should be understood that the embodiments described are not limited to the specific example described below.

In one example, algorithm inputs may be determined for an initial time t=0. For example, the at least one server 102 may receive: an initial quantity q̅ indicative of a quantity of the good to be sold, a base price p̅ indicative of an initial fair market value estimate of the good, an initial maximum price p̅ₘₐₓ of the good, and a maximum time period Tₘₐₓ.

In some embodiments, the initial quantity q̅ may be received by the at least one server 102, such as when a user provides the initial quantity q̅ (directly or indirectly) to the at least one server 102. In other embodiments, the initial quantity q̅ may be received by the at least one server 102 from a computing device other than the at least one server 102, which transmits the initial quantity q̅ to the at least one server 102. In some embodiments, the initial quantity q̅ may be a limited quantity of a good that is to be sold via an electronic commerce web site. However, it should be understood that in other embodiments, the initial quantity q̅ may be a quantity of a good that is to be sold in a way other than by an electronic commerce web site, such as when the good may be sold in a physical store.

In some embodiments, the base price p̅ may be received by the at least one server 102, such as when a user provides the base price p̅ (directly or indirectly) to the at least one server 102. In other embodiments, the base price p̅ may be received by the at least one server 102 from a computing device other than the at least one server 102, which transmits the base price p̅ to the at least one server 102. In some embodiments, the base price p̅ may be an educated guess of the fair market value of the good at the initial time. The base price p̅ serves as an initial price point of the good that is updated as time progresses, as will be described below.

In some embodiments, the initial maximum price p̅ₘₐₓ may be received by the at least one server 102, such as when a user provides the initial maximum price p̅ₘₐₓ (directly or indirectly) to the at least one server 102. In other embodiments, the initial maximum price p̅ₘₐₓ may be received by the at least one server 102 from a computing device other than the at least one server 102, which transmits the initial maximum price p̅ₘₐₓ the at least one server 102. In some embodiments, the initial maximum price p̅ₘₐₓ be an educated guess of the highest price a user may pay for the good at the initial time. The initial maximum price p̅ₘₐₓ be updated as time progresses and the updated maximum price may be used to calculate the current price of the good at any given time, as will be described below.

In some embodiments, the maximum time period Tₘₐₓ may be received by the at least one server 102, such as when a user provides the maximum time period Tₘₐₓ (directly or indirectly) to the at least one server 102. In other embodiments, the maximum time period Tₘₐₓ may be received by the at least one server 102 from a computing device other than the at least one server 102, which transmits the maximum time period Tₘₐₓ to the at least one server 102. In some embodiments, the maximum time period Tₘₐₓ may be a fixed duration of time during which the good is offered for sale. By establishing a maximum time period during which the good is offered for sale, the speed at which the good sells may be increased and profits may be enhanced.

From the algorithm inputs at the initial time, the price of the good, quantity of the good, maximum price of the good, sales velocity, sales acceleration, and demand of the good at the initial time may be determined as follows:

p₀= p̅

q₀= q̅

Pₘₐₓ_{₀}= p̅ₘₐₓ

V₀=0

A₀=0

D₀=0

Then, as the value of t is incremented from 0 to Tₘₐₓ, the price of the good at time t may be iteratively updated according to the method described in flowchart 200. For example, in one embodiment, if Tₘₐₓ=14 days such that the good was only to be sold for 14 days, and the price of the good is updated, the method of flowchart 200 would be performed once a day for t=1 to t=14, with t increasing by 1 each day. In some embodiments, the algorithm may terminate when the quantity of the good is zero (e.g., when the limited quantity of the good sells out before the expiration of the maximum time period).

Referring once again to FIG. 1, in some embodiments, a consumer looking to purchase goods from a company employing the algorithms described herein may have a few purchasing options presented to them such as via a web browser of a client 104 in communication with the at least one server 102. A first option may be to purchase a good that is in a pre-purchase time period, which may be a finite length of time from when the product is first made available for purchase. In some embodiments, the pre-purchase time period may be based on a time when goods may be available to be shipped by a supplier. For example, in some embodiments, the pre-purchase time period may be the lead-time required for a supplier to ship the goods plus a few extra days.

A second option for purchasing goods presented to a consumer via a web browser of the client 104 may be to purchase a good that is in a current offering time period. Goods in the current offering time period may be available to purchase immediately at a current offering price. In some embodiments, the goods available in the current offering time period can be products that have passed through the initial pre-purchase time period and have not been sold out when the pre-purchase time period has elapsed. In such embodiments, the current offering time period is after the pre-purchase time period.

In some embodiments that allow a consumer to purchase a good during a pre-purchase time period and allow the consumer to purchase the good during a current offering period if a quantity of the good remains after the expiration of the pre-purchase time period, the server 102 may calculate a pre-purchase price of the good during the pre-purchase time period. The pre-purchase price is associated with a limited quantity of the good available during the pre-purchase time period. In some embodiments, the pre-purchase price may be calculated and/or updated according to the algorithm 200 described above with reference to FIG. 2. The pre-purchase price may be transmitted to client 104 for display to a user of the client 104 (e.g., via a webpage). The server 102 may then determine a sold quantity of the good during a current period within the pre-purchase time period, such as by calculating a difference between a quantity of the good remaining at the beginning of the current period and the quantity of the good remaining at the end of the current period.

Some embodiments may calculate a risk metric based on the limited quantity (e.g., the initial quantity to be sold) and the quantity sold during the current period. The risk metric is indicative of a risk that the limited quantity of the good will sell out during the pre-purchase time period. In some embodiments, the risk metric may be inversely proportional to a remaining quantity of the good, such that the risk metric is inversely proportional to the remaining quantity (e.g., when the remaining quantity is low, the risk of selling). In some embodiments, the risk metric may be transmitted to client 104 for display to a user of the client 104 (e.g., via a webpage) during the pre-purchase time period, such that the display indicates a risk that the good will sell out during the pre-purchase time period (e.g., by displaying text, such as “High,” “Medium,” “Low,” or displaying an icon indicative of a risk that the good will sell out, such as a red icon to indicate a high risk, an orange icon to indicate a medium risk and a green icon to indicate a low risk). In other embodiments, the risk metric may be displayed in a manner other than described above. In some embodiments, the risk metric may be provided via a risk meter, which can be listed next to every launched product.

In some embodiments, when a quantity of the good remains after the expiration of the pre-purchase time period (e.g., the good has not sold out during the pre-purchase time period), the server 102 may calculate a current offering price that is lower than the pre-purchase price and transmit the calculated current offering price during a current offering time period. In some embodiments, the current offering price may be calculated based on a remaining quantity of the good after the pre-purchase time period has elapsed. The pre-purchase price of the good may be higher than the current offering price because it is believed that consumers may be more inclined to purchase at higher prices initially because the quantity of inventory may be limited. Thus, if consumers want to guarantee that they will be able to purchase the good, they may wish to purchase the good during the pre-purchase time period at a higher price than they might be able to purchase the price during the current offering time period. Moreover, consumers may desire to avoid waiting for the lower price when the product makes it to the current offering and risking that the product will be sold out.

It should now be understood that embodiments described herein provide methods and electronic commerce systems for updating the price of goods. By updating the price of goods as the quantity of the goods changes over time, enhanced profits from the sale of the goods may be realized. Furthermore, by selling a limited quantity of a good during a pre-purchase time period after which the good will no longer be available for purchase, profits may be enhanced.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for displaying an updated price of a good comprising:
determining, automatically by a computing device, a current sales velocity, wherein the current sales velocity is a sold quantity of the good during a current period, wherein the current period spans a previous time and a current time;
determining a previous sales velocity, wherein the previous sales velocity is a sold quantity of the good during a previous period, wherein the previous period spans a preceding previous time and the previous time;
updating the price of the good based on the current sales velocity and the previous sales velocity; and
providing for display the updated price of the good on a display device.

2. The method of claim 1, further comprising calculating a current sales acceleration by subtracting the previous sales velocity from the current sales velocity, wherein the price of the good is updated based on the current sales acceleration.

3. The method of claim 2, further comprising calculating a current demand based on the current sales acceleration, wherein the price of the good is updated based on the current demand.

4. The method of claim 3, wherein the current demand is calculated based on a previous maximum price, wherein the previous maximum price is indicative of a maximum price of the good at the previous time.

5. The method of claim 4, wherein the current demand is calculated by:
determining an acceleration difference by subtracting a previous sales acceleration from the current sales acceleration; and
dividing the acceleration difference by the previous maximum price to arrive at the current demand.

6. The method of claim 3, further comprising calculating a current maximum price based on the current demand and a previous maximum price, wherein the current maximum price is indicative of a maximum price of the good at the current time and the previous maximum price is indicative of a maximum price of the good at the previous time, and wherein the price of the good is updated based on the current maximum price.

7. The method of claim 1, wherein the price of the good is updated during a fixed period and only a limited quantity of the good is available for sale during the fixed period.

8. The method of claim 7, wherein the fixed period is a pre-purchase time period and the price of the good is a pre-purchase price of the good.

9. An electronic commerce system for updating a price of a good comprising:
at least one processor;
a memory communicatively coupled to the at least one processor; and
machine readable instructions stored in the memory that cause the electronic commerce system to perform at least the following when executed by the at least one processor:
determine a current sales velocity, wherein the current sales velocity is a sold quantity of the good during a current period, wherein the current period spans a previous time and a current time;
determine a previous sales velocity, wherein the previous sales velocity is a sold quantity of the good during a previous period, wherein the previous period spans a preceding previous time and the previous time; and
update the price of the good based on the current sales velocity and the previous sales velocity.

10. The electronic commerce system of claim 9, wherein the machine readable instructions stored in the memory further cause the electronic commerce system to transmit the updated price of the good for display by a client computing device communicatively coupled to the electronic commerce system.

11. The electronic commerce system of claim 9, wherein the machine readable instructions stored in the memory further cause the electronic commerce system to:
calculate a current sales acceleration by subtracting the previous sales velocity from the current sales velocity;
calculate a current demand based on the current sales acceleration and a previous maximum price, wherein the previous maximum price is indicative of a maximum price of the good at the previous time; and
calculate a current maximum price based on the current demand and the previous maximum price, wherein the current maximum price is indicative of a maximum price of the good at the current time, and wherein the price of the good is updated based on the current maximum price.

12. The electronic commerce system of claim 9, wherein the price of the good is updated during a pre-purchase time period, and only a limited quantity of the good is available for sale during the pre-purchase time period.

13. An electronic commerce system comprising:
at least one processor;
a memory communicatively coupled to the at least one processor; and
machine readable instructions stored in the memory that cause the electronic commerce system to perform at least the following when executed by the at least one processor:
calculate a pre-purchase price of a good during a pre-purchase time period, wherein the pre-purchase price is associated with a limited quantity of the good available for sale during the pre-purchase time period;
transmit the pre-purchase price of a good;
determine a sold quantity of the good during a current period within the pre-purchase time period;
calculate a risk metric based on the limited quantity and the sold quantity;
transmit the risk metric;
calculate a current offering price, wherein the current offering price is lower than the pre-purchase price; and
transmit the current offering price during a current offering time period.

14. The electronic commerce system of claim 13, wherein the current offering time period is after the pre-purchase time period.

15. The electronic commerce system of claim 14, wherein the current offering price is calculated based on a remaining quantity of the good after the pre-purchase time period has elapsed.

16. The electronic commerce system of claim 13, wherein the risk metric is transmitted during the pre-purchase time period, wherein the risk metric is indicative of a risk that the limited quantity of the good will sell out during the pre-purchase time period.

17. The electronic commerce system of claim 13, wherein the machine readable instructions stored in the memory that cause the electronic commerce system to calculate a risk metric based on the allocated quantity and the received sales data further cause the electronic commerce system to:
determine a remaining quantity of the good; and
calculate the risk metric based on the remaining quantity, such that the risk metric is inversely proportional to the remaining quantity.

18. The electronic commerce system of claim 13, wherein the machine readable instructions stored in the memory further cause the electronic commerce system to:
provide for display the risk metric on a client computing device communicatively coupled to the electronic commerce system.

19. The electronic commerce system of claim 13, wherein the machine readable instructions stored in the memory further cause the electronic commerce system to:
determine a current sales velocity, wherein the current sales velocity is the sold quantity of the good during a current period, wherein the current period spans a previous time and a current time;
determine a previous sales velocity, wherein the previous sales velocity is the sold quantity of the good during a previous period, wherein the previous period spans a preceding previous time and the previous time; and
update the pre-purchase price of the good based on the current sales velocity and the previous sales velocity; and
transmit the updated pre-purchase price of the good for display by a client computing device communicatively coupled to the electronic commerce system during the pre-purchase time period.

20. The electronic commerce system of claim 19, wherein the machine readable instructions stored in the memory further cause the electronic commerce system to:
calculate a current sales acceleration by subtracting the previous sales velocity from the current sales velocity;
calculate a current demand based on the current sales acceleration and a previous maximum price, wherein the previous maximum price is indicative of a maximum price of the good at the previous time; and
calculate a current maximum price based on the current demand and the previous maximum price, wherein the current maximum price is indicative of a maximum price of the good at the current time, and wherein the price of the good is updated based on the current maximum price.
